(19) United States
(12) Patent Application Publication
(10) Pub. No.: US 2011/0175343 A1
(43) Pub. Date: Jul. 21, 2011

(54) Identification system for drill pipes and the like

(75) Inventor: Charles Thomas Akins, Kilgore, TX (US)

(73) Assignee: Pipe Maintenance, Inc., Kilgore, TX (US)

(21) Appl. No.: 13/065,647

(22) Filed: Mar. 24, 2011

Related U.S. Application Data
(63) Continuation-in-part of application No. 11/342,395, filed on Jan. 30, 2006.
(60) Provisional application No. 60/648,598, filed on Jan. 31, 2005.

(51) Int. Cl. B42D 15/00

(52) U.S. Cl. 283/74

(57) ABSTRACT

An identification system for marking a component which in use is subject to wear includes an identification disk which comprises generally parallel upper and lower faces and a thickness which is defined between the upper and lower faces, a unique identifying marking which is provided on at least the upper face and which corresponds to the identity of the component, a cavity which is formed in the body of the component and extends from the outer surface of the body to a depth that is greater than the thickness of the disk, and a lip which is formed from a portion of the body adjacent the cavity and which, when the disk is positioned in the cavity, overlaps an outer peripheral portion of the upper face to thereby secure the disk in the cavity without obscuring the identifying marking.

This application is a continuation-in-part of U.S. patent application Ser. No. 11/342,395 filed on Jan. 30, 2006.

### BACKGROUND OF THE INVENTION

The present invention is directed to a system and method for marking components so that they can be identified and tracked. In particular, the invention is directed to a system and method which comprises an identification disk having identifying markings disposed thereon which are unique to the particular component to which the disk is or will be mounted. One component with which the identification system and method of the present invention may be employed is a drill pipe.

Drill pipes are commonly used to drill and service oil and gas wells. Such drill pipes are exposed to extreme conditions of temperature, pressure, and abrasion. Failure of a drill pipe during use can create significant problems for the drilling operator by imposing both delays and recovery expenses. Because of the extreme conditions to which they are subjected and the consequences of failure, drill pipes are typically constructed of high grade, costly materials. Consequently, the inventory of drill pipe used to drill a typical oil or gas well represents a significant investment. Accordingly, it has become a relatively common practice to mark each section of the drill pipe with an identifying number to allow information about the drill pipe, including its location and service life, to be monitored and maintained.

Various approaches to identifying sections of drill pipe exist. In one approach an identifying number is engraved into the surface of the pipe. This approach is reasonably effective so long as the identifying number remains visible. However, because drill pipes are subject to abrasion, the surface of the drill pipe is worn away during use, and over a period of time the identifying number may disappear.

In another approach to identifying sections of drill pipe, a small electronic module which can be read with a reader or scanner unit is inserted into a cavity formed in the wall of the drill pipe and the cavity is filled with a potting material or the like to seal the module in place. Although recessing the electronic module in a closed cavity effectively protects it from abrasion, the module is not protected from the high temperatures and temperature variations to which the drill pipe is subjected, and the failure rate of the electronic tags is therefore relatively high.

The abrasion to which drill pipes are subjected eventually erodes the pipe sections to the point where they can no longer be used because of the increased risk of failure. Accordingly, drilling operators typically monitor the wear of each section of drill pipe and retire a section when the wear reaches a preselected limit, which is often referred to the wear allowance. This monitoring is typically done by measuring the diameter of the pipe section, which requires a worker to manually apply a measuring tool or gauge to the pipe.

It can be understood then that a need exists for an effective means of individually marking sections of drill pipe so that each section can be identified and tracked. A need also exists for a more effective and less labor intensive means of monitoring the degree of wear to individual sections of drill pipe and determining when a section should be taken out of service.

### SUMMARY OF THE INVENTION

In accordance with the present invention, these and other limitations in the prior art are addressed by providing an identification system for a component which comprises a body having an outer surface which in use is subject to wear. The system includes an identification disk which comprises generally parallel upper and lower faces and a thickness which is defined between the upper and lower faces; a unique identifying marking which is provided on at least the upper face, the identifying marking corresponding to the identity of the component; a cavity which is formed in the body and extends from the outer surface to a depth that is greater than the thickness of the disk; wherein in use of the identification system the disk is positioned in the cavity such that the upper face is directed toward and disposed below the outer surface; and a lip which is formed from a portion of the body adjacent the cavity and which, when the disk is positioned in the cavity, overlaps an outer peripheral portion of the upper face to thereby secure the disk in the cavity without obscuring the identifying marking.

In accordance with one embodiment of the invention, the cavity comprises an inner portion within which the disk is positioned; an outer portion which extends between the inner portion and the outer surface; and a shoulder which is located between the inner and outer portions; wherein the lip is formed from the shoulder. In this embodiment, the inner portion may comprise a depth which is greater than the thickness of the disk.

In accordance with yet another embodiment of the invention, the inner portion comprises a first diameter, the outer portion comprises a second diameter which is greater than the first diameter, and the shoulder comprises a generally square profile. In this embodiment, the inner portion may comprise a depth which is greater than the thickness of the disk.

In accordance with a further embodiment of the invention, the inner portion comprises a first diameter, the outer portion comprises a second diameter which is greater than the first diameter, and the shoulder comprises a radially inner portion which is located a first distance from the outer surface and a radially outer portion which is located a second distance from the outer surface. In this embodiment, the first distance is less than the second distance and the shoulder may comprise, e.g., a generally triangular profile, a concave profile, or a convex profile, among other configurations.

In any of the above embodiments, the lip may comprise an upper portion which is located proximate the bottom of a wear allowance zone of the component.

The present invention is also directed to a method for providing a component with a unique identifying marking. The method includes providing an identification disk which comprises generally parallel upper and lower faces and a thickness which is defined between the upper and lower faces; disposing the identifying marking on at least the upper face; forming a cavity in the body which extends from the outer surface to a depth which is greater than the thickness of the disk; positioning the disk in the cavity such that the upper face is directed toward and disposed below the outer surface; and forming a lip from a portion of the body adjacent the cavity such that, when the disk is positioned in the cavity, the lip overlaps an outer peripheral portion of the upper face to thereby secure the disk in the cavity without obscuring the identifying marking.

Thus, the identification system and method of the present invention provides a simple yet effective means for marking components such as sections of drill pipe so that they can be identified and tracked. The identification disk is preferably made of a durable material, such as stainless steel. Consequently, the disk is relatively impervious to extreme temperatures and pressures. In addition, the disk is retained in the cavity by a lip which is formed integrally with the body of the component. Thus, little to no risk exists that the disk will be dislodged during use of the component. Also, the cavity may be configured and the lip formed such that an upper portion of the lip is located proximate the wear allowance zone of the component. Thus, as the surface of the component is worn down during use, exposure of the upper portion of the lip will provide a visual indication that the component has reached its wear allowance and should be replaced.

These and other objects and advantages of the present invention will be made apparent from the following detailed description, with reference to the accompanying drawings. In the drawings, the same reference numbers may be used to denote similar components in the various embodiments.

### BRIEF DESCRIPTION OF THE DRAWINGS

FIG. 1 is a top plan view of one embodiment of an identification disk which is suitable for use in the identification system and method of the present invention;

FIG. 2 is a side elevation view of the identification disk shown in FIG. 1;

FIG. 3 is an illustrative example of a two dimensional code marking which is suitable for use in the identification system and method of the present invention;

FIG. 4 is a top plan view of the identification disk of FIG. 1 shown mounted in a representative section of drill pipe;

FIG. 5 is a cross sectional view of the drill pipe and identification disk of FIG. 4 taken along line 5-5;

FIG. 6 is a cross sectional view similar to FIG. 5, but illustrating the drill pipe having been worn down to the point requiring that it be removed from service;

FIG. 7 is a top plan view of an alternative embodiment of an identification disk which is suitable for use in the identification system and method of the present invention;

FIG. 8 is a top plan view of the identification disk of FIG. 1 shown mounted to a representative section of drill pipe in accordance with another embodiment of the present invention;

FIG. 9 is an enlarged cross sectional view of the drill pipe and identification disk of FIG. 8 taken along line 9-9;

FIG. 10 is a cross sectional representation of the drill pipe of FIG. 8 showing one embodiment of a cavity within which the identification disk of FIG. 1 may be mounted;

FIG. 10a is an enlarged view of the cavity shown in FIG. 10;

FIG. 11 is a cross sectional representation of the drill pipe of FIG. 8 showing another embodiment of a cavity within which the identification disk of FIG. 1 may be mounted;

FIG. 11a is an enlarged view of the cavity shown in FIG. 11;

FIG. 12 is an enlarged view similar to FIG. 11a but showing a further embodiment of a cavity within which the identification disk of FIG. 1 may be mounted;

FIG. 13 is an enlarged view similar to FIG. 11a but showing still another embodiment of a cavity within which the identification disk of FIG. 1 may be mounted;

FIGS. 14a-14c are cross sectional representations showing the sequence of mounting the identification disk of FIG. 1 into a representative section of drill pipe in accordance with one embodiment of the method of the present invention;

FIG. 15 is an enlarged cross sectional view of another embodiment of an identification disk which is suitable for use with the identification system and method of the present invention; and

FIG. 16 is an enlarged cross sectional view of yet another embodiment of an identification disk which is suitable for use with the identification system and method of the present invention.

### DETAILED DESCRIPTION OF THE INVENTION

The present invention is directed to a system and method for affixing a component with unique identifying markings to enable the component to be identified and tracked throughout its life. The invention involves mounting an identification disk comprising the unique identifying markings within a cavity formed in the body of the component. Although the invention has wide application to various types of components, it will be described herein in the context of a section of drill pipe. In this context, the wall of the drill pipe is analogous to the body of the component.

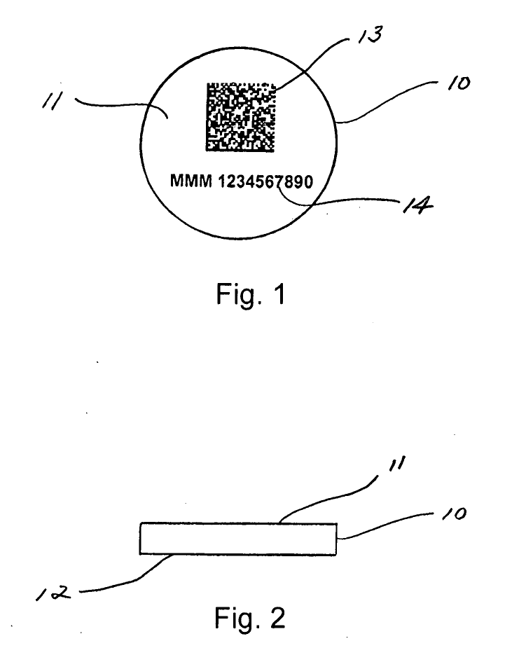

Referring to FIGS. 1 and 2, the identification system of one embodiment of the present invention comprises an identification disk 10 having generally parallel upper and lower faces 11, 12. At least the upper face 11 and preferably also the lower face 12 are provided with one or more unique identifying markings or indicia which correspond to the identity of a distinct section of drill pipe or the like to which the disk 10 is or will be mounted. The identifying markings may comprise, for example, a machine readable code marking 13. Alternatively or in addition to the code marking 13, the identifying markings may comprise an alpha-numeric identification number 14 which can be directly read by a human.

In an exemplary embodiment of the invention, the disk 10 is a planar body formed of 316 stainless steel. In addition, the disk 10 ideally comprises a circular configuration having a diameter of approximately one inch and a thickness between the upper and lower faces 11, 12 of about one-tenth inch. However, it should be recognized that the disk 10 may be formed of other suitably durable materials and may comprise other configurations and/or dimensions.

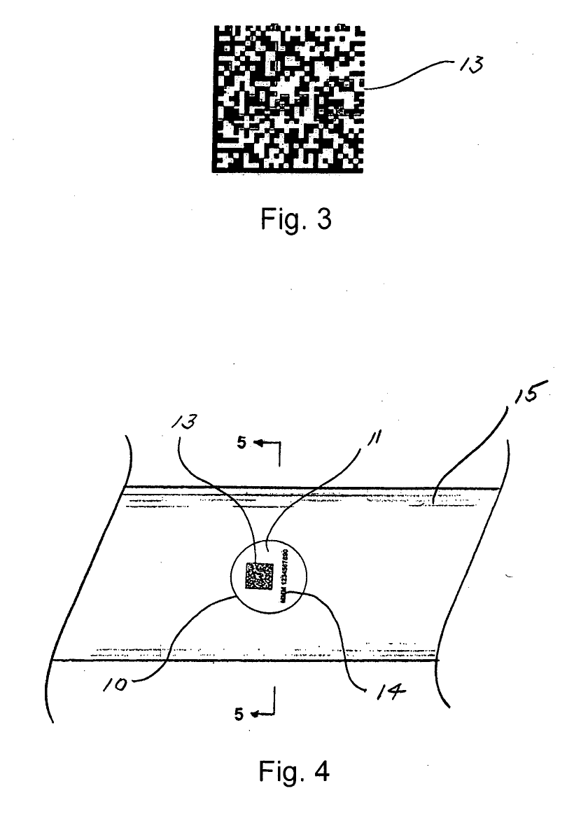

As shown in FIG. 3, the machine readable code marking 13 is ideally comprised of a two dimensional matrix code. Two dimensional codes have several advantages over traditional one dimensional bar codes, including permitting significantly more information or data to be stored in a given area. For example, a typical one dimensional bar code is limited to fourteen characters of data, whereas a two dimensional code can represent up to several hundred characters of data. In an exemplary embodiment of the invention, approximately sixty characters of data are stored in the two dimensional code marking 13.

Two dimensional codes also allow for data redundancy. Thus, if a portion of the two dimensional code marking 13 is damaged, the data represented by the code may be read from an undamaged portion of the code marking. The data redundancy provided by the two dimensional code marking 13 is particularly significant when the coded article, such as a section of drill pipe, is subject to conditions that increase the risk of damage to the code marking.

Although the code marking 13 is described herein as comprising a two dimensional code, it should be understood that the system of the present invention is not so limited and that the code marking may comprise any available code, including but not limited to a traditional one dimensional bar code.

The code marking 13 and the identification number 14, if used, are preferably laser engraved on the disk 10. Although other means of applying these markings to the disk 10 could be used without deviating from the principles of the invention, laser engraving is preferred because it results in the markings being slightly cut into the material of the disk, and this provides improved durability and readability to the markings. Markings formed by laser engraving are also highly resistant to degradation from chemicals encountered in typical drilling operations and are not affected by the high temperatures and pressures to which the drill pipe may be subjected during use. The specific placement of the code marking 13 and the optional identification number 14 on at least the upper face 11 of the disk 10 is not critical, although it is preferred that the code marking 13 not be disposed at the outer peripheral portion of the disk.

The identifying markings comprising the code marking 13 and the optional identification number 14 represent a discrete and unique code which can be used to identify each individual section of drill pipe or the like to which the disk 10 is or will be mounted. Each user of the system of the present invention may determine the specific data to be represented by the identifying markings. As noted above, the data storage capability of the two dimensional code employed for the code marking 13 allows for the storage of a significant volume of data, and that capability may be utilized in any desired manner.

In a preferred embodiment of the invention, at least a portion of the identifying markings comprising the code marking 13 and the optional identification number 14 represents a unique serial number for each section of drill pipe or the like to which the disk 10 is or will be mounted. In this manner, a comprehensive database may be established and maintained for recording the complete history of a section of drill pipe, and this history may be accessed by the serial number. Thus, when the serial number is read from a section of drill pipe, the desired information about the drill pipe can be readily accessed from the database. The data storage capability of the two dimensional code marking 13 also allows information about a section of drill pipe to be stored directly on the drill pipe so that it may be immediately available from a scanner read-out without having to access, e.g., a remotely maintained database.

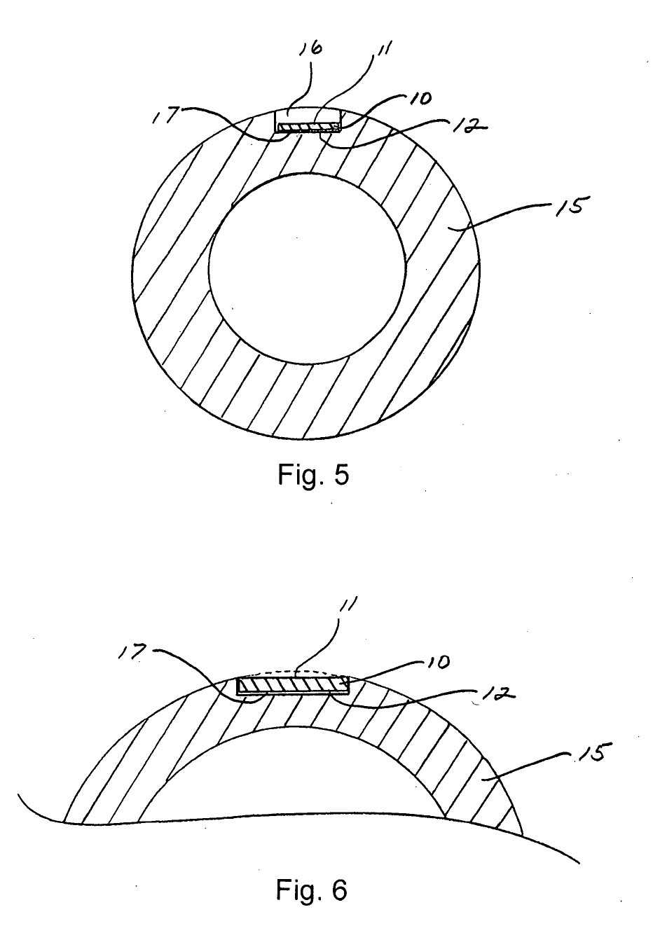

As generally illustrated in FIGS. 4 and 5, in one embodiment of the invention each disk 10 is associated with a section of drill pipe 15 by embedding the disk within a cavity 16 which extends into the body or wall of the drill pipe from the outer surface thereof. As shown in FIG. 5, the depth of the cavity 16 is preferably greater than the thickness of the disk 10 so that the upper face 11 of the disk will be countersunk below the outer surface. The disposition of the upper face 11 below the outer surface protects the identifying markings from abrasion and erosion and thereby contributes to the continued readability of the identifying markings over the useful life of the drill pipe.

In one embodiment of the invention, the disk 10 is secured in the cavity 16 by means of an adhesive material 17 which is disposed between the bottom of the cavity and the lower face 12 of the disk. Alternatively, other means of securing the disk 10 in the cavity 16 may be employed, so long as the identifying markings on the upper face 11 are not obscured. Also, it is preferred that the disk 10 be removable from the cavity so that, in the event the identifying markings on the upper face 11 become unreadable, the disk may be removed from the cavity 16 and the same markings on the lower face 12 of the disk may be read. A replacement disk 10 may then be secured in the cavity 16 to assure continued tracking of the drill pipe 15.

In a preferred embodiment of the invention, the cavity 16 is left open above the upper face 11 of disk 10. Although some debris may accumulate in this portion of the cavity 16 during use of the drill pipe, such debris may be easily removed before scanning the code marking 13 or reading the identification number 14. Moreover, the presence of debris may actually serve to protect the upper face 11 of the disk 10. Although not preferred, the cavity 16 may be filled above the disk 10 with, e.g., a transparent material or a removable plug.

It should be noted that boring or otherwise forming the relatively small cavity 16 into the wall of the drill pipe will not compromise the strength or durability of the drill pipe or reduce its utility. The location of the cavity 16 is subject to some variation and is within the discretion of the user or manufacturer; however, the cavity is ideally disposed in a location which is subject to wear and erosion in order to take full advantage of the features of the present invention. For example, the cavity 16 may be disposed in a collar or tool joint of the drill pipe.

In addition to providing a secure and protected identification system for sections of drill pipe and the like, the system of the present invention also affords a simple and reliable means for monitoring the wear experienced by a section of drill pipe so that a determination can be made as to whether that section should be removed from service. During use, the surface of a section of drill pipe is abraded away, and when the diameter of the monitored area of the drill pipe is reduced to a predetermined minimum dimension, the section of drill pipe may no longer be used.

Thus, in accordance with one embodiment of the invention, the cavity 16 is bored to a depth approximately equal to the thickness of the disk 10 plus the wear allowance zone of the drill pipe. In this manner, the distance between the outer surface of the drill pipe and the upper face 11 of the disk will be equal to the depth of the wear allowance zone. During use of the drill pipe, the wear allowance zone will gradually decrease as the pipe wears and the diameter of the pipe is reduced. As shown in FIG. 6, since the cross-sectional configuration of the drill pipe is circular and the upper face 11 of the disk 10 is flat, erosion of the drill pipe will expose the peripheral edge of the disk before the central portion of the upper face 11 is exposed to abrasion. Therefore, the identifying markings will still be readable when the section of drill pipe has worn to the point at which it must be removed from service. Thus, with the system of the present invention, monitoring the wear of sections of drill pipe may be reliably performed visually, without the need to actually measure the diameter of the pipe.

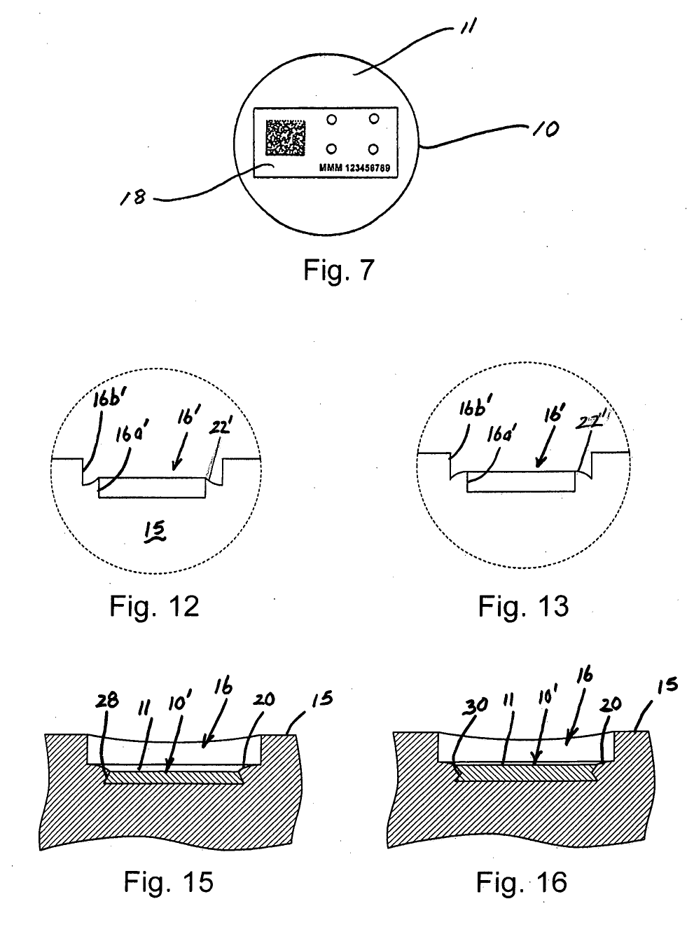

A number of variations and alternative embodiments are within the scope of the present invention. In one variation, the identifying indicia could be omitted from the lower face 12 of the disk 10. In another variation, the identifying indicia may be engraved or otherwise applied to a thin, preferably metal tag 18 which is attached to the upper face 11 of the disk 10, as illustrated in FIG. 7.

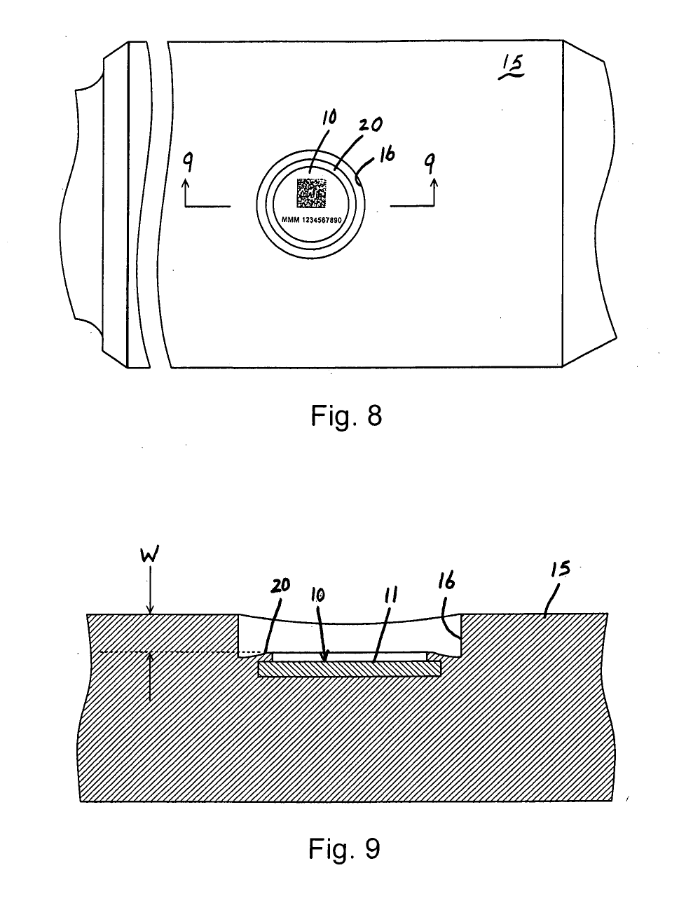

Another embodiment of the identification system of the present invention is shown in FIGS. 8 and 9. In this embodiment, the disk 10 is retained in the cavity 16 by an annular lip 20. The lip 20 is formed after the disk 10 has been positioned in the cavity 16. In addition, the lip 20 is configured to overlap only the periphery of the disk 10 so that it will securely retain the disk in the cavity 16 without obscuring the identifying markings located on the top surface 11. Furthermore, the lip 20 may be formed so that an upper portion of the lip is located proximate the bottom of the wear allowance zone W of the drill pipe 15. Thus, as the surface of the drill pipe 15 is worn down through use, exposure of the upper portion of the lip 20 will provide a visual indication that the drill pipe has reached its wear allowance and should be replaced.

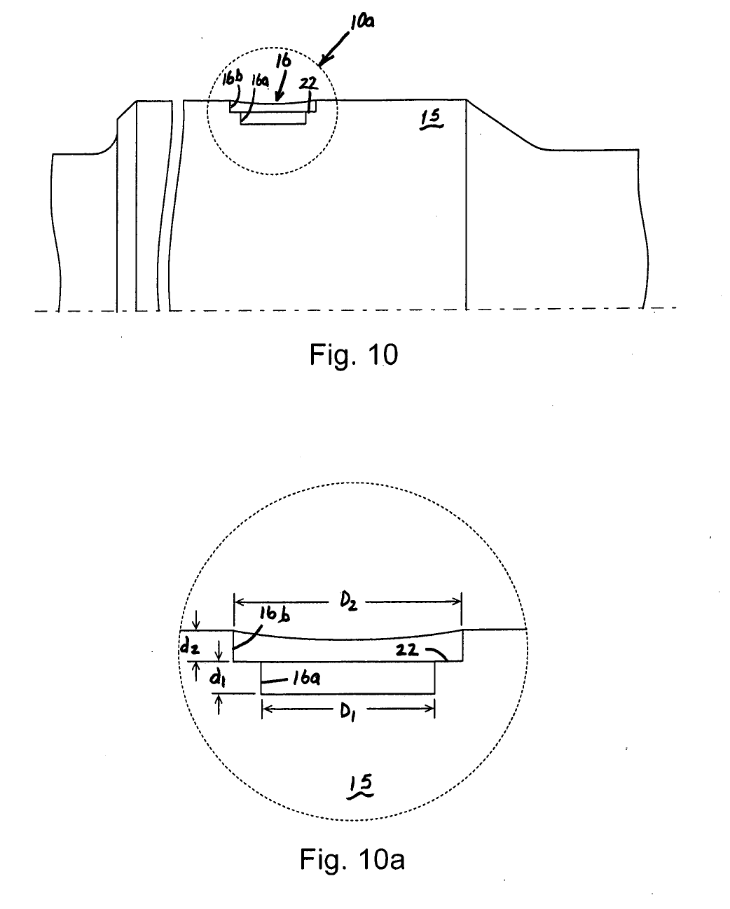

In accordance with the present invention, the cavity 16 is specifically configured to facilitate the formation of the lip 20 from a portion of the wall of the drill pipe adjacent the cavity. Referring to FIGS. 10 and 10a, for example, in one embodiment of the invention the cavity 16 comprises an inner portion 16a within which the disk 10 is positioned, an outer portion 16b which extends between the inner portion and the surface of the drill pipe 15, and an annular shoulder 22 which is located between the inner and outer portions. In this embodiment, the inner and outer portions 16a, 16b comprise generally cylindrical configurations, the diameter D₁ of the inner portion is less than the diameter D₂ of the outer portion, and the shoulder 22 comprises a generally square profile. As will be discussed more fully below, the lip 20 is formed by compressing the shoulder 22 over the outer periphery of the disk 10, for example using a press forging process. Thus, the lip 22 comprises an integral part of the drill pipe 15 which will securely retain the disk 10 within the cavity 16 without obscuring the identifying markings on the upper face 11 of the disk.

In the embodiment of the invention shown in FIGS. 10 and 10a, the diameter D₁ of the inner portion 16a of the cavity is about the same as or slightly larger than the diameter of the disk 10. In addition, the depth d₁ of the inner portion 16a of the cavity, which also corresponds to the height of the shoulder 22 from the bottom of the cavity, is designed to be greater than the thickness of the disk 10 by an amount which is sufficient to provide the shoulder with adequate material above the disk from which to form a lip 20 having a desired thickness and radial width. Furthermore, the depth d₂ of the outer portion 16b of the cavity may be chosen to result in an upper portion of the lip 20 being located proximate the bottom of the wear allowance zone W of the drill pipe 15. In an exemplary and non-limiting embodiment of the invention, where the disk 10 comprises a diameter of 1.00″ and a thickness of 0.10″, the cavity 16 may comprise the following dimensions: D₁=1.000″; d₁=0.200″; D₂=1.250″; and d₂=0.200″. These dimensions would be appropriate, for example, when the cavity 16 is formed in a drill pipe tool joint which comprises a new outer diameter of 6.625″ and a wear allowance zone of 0.3125″ (i.e. a minimum outer diameter of 6.3125″).

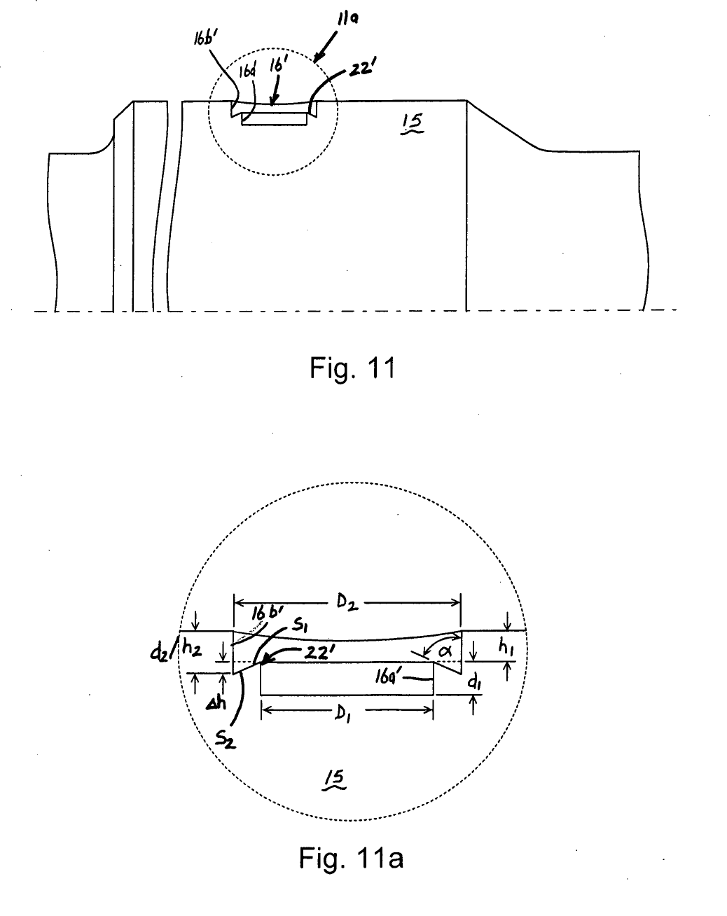

Another embodiment of the present invention is shown in FIGS. 11 and 11a. Similar to the embodiment described immediately above, the cavity 16′ of this embodiment of the invention comprises an inner portion 16a′ within which the disk 10 is positioned, an outer portion 16b′ which extends between the inner portion and the surface of the drill pipe, and an annular shoulder 22′ which is located between the inner and outer portions. In addition, the diameter D₁ of the inner portion 16a′ is less than the diameter D₂ of the outer portion 16b′. In contrast with the shoulder 22 of the previous embodiment, however, the shoulder 22′ comprises an inclined profile. In particular, the shoulder 22′ comprises a radially inner portion S₁ which is located a first distance h₁ from the outer surface of the drill pipe and a radially outer portion S₂ which is located a second distance h₂ from the outer surface of the drill pipe that is greater than the first distance. Thus, the shoulder 22′ comprises a generally triangular profile which forms an angle α with the outer portion 16b′ of the cavity and comprises a height Δh of h₂−h₁. However, the shoulder 22′ could comprise other configurations, including but not limited to a concave profile as shown in FIG. 12 or a convex profile as shown in FIG. 13.

As in the previous embodiment, the lip 20 is formed by compressing the shoulder 22′ over the outer periphery of the disk 10 using, for example, a press forging process. Since the shoulder 22′ is inclined rather than square, the radially outer surface, or hypotenuse, of the shoulder is not connected to the wall of the drill pipe. Consequently, much less force is required to compress the shoulder into the shape of the lip 20. In addition, the inclined shape of the shoulder 22′ allows better control to be maintained over the shape of the lip 20 during the forming process.

In the embodiment of the invention shown in FIGS. 11 and 11a, the diameter D₁ of the inner portion 16a′ of the cavity is about the same as or slightly larger than the diameter of the disk 10. In addition, the depth d₁ of the inner portion 16a′ of the cavity, which also corresponds to the height of the shoulder 22′ above the bottom of the cavity, is designed to be greater than the thickness of the disk 10 by an amount which is sufficient to provide the shoulder with adequate material above the disk from which to form a lip 20 having a desired thickness and radial width. Furthermore, the depth d₂ of the outer portion 16b′ of the cavity may be chosen to result in an upper portion of the lip 20 being located proximate the bottom of the wear allowance zone W of the drill pipe 15. In an exemplary and non-limiting embodiment of the invention, where the disk 10 comprises a diameter of 1.00″ and a thickness of 0.10″, the cavity 16′ may comprise the following dimensions: D₁=1.000″; d₁=0.200″; D₂=1.250″; d₂=h₂=0.200″; α=60°; and Δh=0.045″. These dimensions would be appropriate, for example, when the cavity 16 is formed in a drill pipe tool joint which comprises a new outer diameter of 6.625″ and a wear allowance zone of 0.3125″ (i.e. a minimum outer diameter of 6.3125″).

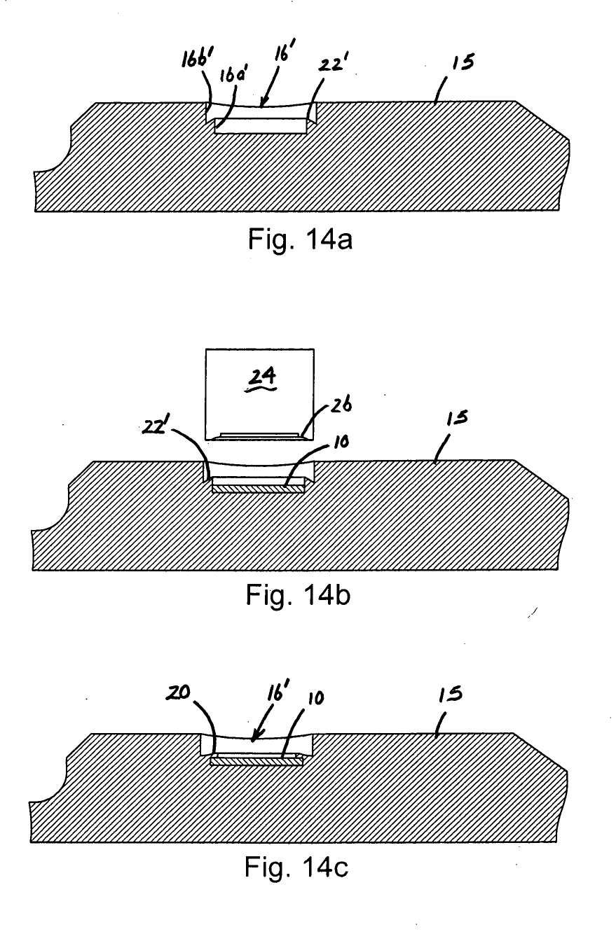

The method of mounting the disk 10 to a section of drill pipe 15 in accordance with the present invention will now be described with reference to FIGS. 14a-14c. The first step of the method involves forming the cavity, such as cavity 16′, in the wall of the drill pipe 15. This may be accomplished by boring a first hole having a diameter D₁ and a total depth d₁+d₂−Δh in the wall of the drill pipe to form the inner portion 16a′ of the cavity. The first hole is then be counterbored with a second hole having a diameter D₂ and a depth d₂ to form the outer portion 16b′ of the cavity. Finally, the second hole is milled using a suitable cutting head to form the triangular shoulder 22′. The resulting cavity 16′ is shown in FIG. 14a.

After the cavity 16a′ is formed in the drill pipe 15, the disk 10 is placed in the inner portion 16a′ of the cavity, as shown in FIG. 14b. The lip 20 is then formed over the disk 10 using, for example, a press forging process. The press forging process employs a die 24 which is mounted in a forging press (not shown) and comprises a recessed profile 26 that corresponds to the desired shape of the lip 20. The lip 20 is formed by inserting the die 24 into the cavity 16′ and pressing the die against the shoulder 22′. The die 24 is advanced with sufficient force to ensure that the lip 20 achieves the desired shape without damaging the disk 10. The resulting lip 20 is shown in FIG. 14c.

If a need arises to remove the disk 10, the lip 20 may be cut away from the wall of the drill pipe 15 using a suitable hole saw. This will leave the disk 10 unrestrained and thereby allow the disk to be easily removed from the cavity 16′.

Although the disk 10 has been described above as having parallel upper and lower faces 11, 12 and a perpendicular peripheral edge, the disk need not be so configured. For example, the upper face 11 may be oblique relative to the lower face 12. In addition, the peripheral edge of the disk 10 may be inclined or grooved. Referring to FIG. 15, for instance, an alternative disk 10′ is shown in which the diameter of the upper face 11 is less than the diameter of the lower face 12. As a result, the peripheral edge 28 of the disk 10′ is inclined radially inwardly from the lower face 12 to the upper face 11. This inclined peripheral edge 28 presents a suitable outer peripheral portion of the disk 10′ over which the lip 20 may be formed to thereby secure the disk within the cavity 16. In another exemplary embodiment of the invention, which is shown in FIG. 16, the disk 10″ comprises an outer peripheral edge in which a circumferential, generally V-shaped groove 30 is formed. As with the inclined peripheral edge 28, the groove 30 presents a suitable outer peripheral portion of the disk 10′ over which the lip 20 may be formed to thereby secure the disk within the cavity 16.

The cavity has been described herein as being circular since such cavities can be easily bored and minimize structural stress on the drill pipe. However, it should be understood that the scope of the present invention encompasses the use of non-circular cavities and non-circular disks 10. For example, the present invention may be used with rectangular cavities and disks. Thus, unless otherwise indicated, the terms “cavity” and “disk” in the foregoing description are to be understood to include non-circular configurations.

It is also to be understood that although the system and method of the invention are particularly useful in the context of identifying, tracking, and monitoring drill pipe, the invention may be effectively utilized for identifying, tracking, and/or monitoring other components. The system of the invention is particularly advantageous for use with components that are subject to ablative wear and/or extreme environments.

It should be recognized that, while the present invention has been described in relation to the preferred embodiments thereof, those skilled in the art may develop a wide variation of structural and operational details without departing from the principles of the invention. Therefore, the appended claims are to be construed to cover all equivalents falling within the true scope and spirit of the invention.

What is claimed is:

1. An identification system for a component which comprises a body having an outer surface which in use is subject to wear, the system comprising:
an identification disk which comprises upper and lower faces and a thickness which is defined between the upper and lower faces;
a unique identifying marking which is provided on at least the upper face, the identifying marking corresponding to the identity of the component;
a cavity which is formed in the body and extends from the outer surface to a depth that is greater than the thickness of the disk;
wherein in use of the identification system the disk is positioned in the cavity such that the upper face is directed toward and disposed below the outer surface; and
a lip which is formed from a portion of the body adjacent the cavity and which, when the disk is positioned in the cavity, overlaps an outer peripheral portion of the disk to thereby secure the disk in the cavity without obscuring the identifying marking.

2. The identification system of claim 1, wherein the lip comprises an upper portion which is located proximate the bottom of a wear allowance zone of the component.

3. The identification system of claim 1, wherein the identifying marking is also provided on the lower face of the disk.

4. The identification system of claim 1, wherein the cavity comprises:
an inner portion within which the disk is positioned;
an outer portion which extends between the inner portion and the outer surface; and
a shoulder which is located between the inner and outer portions;
wherein the lip is formed from the shoulder.

5. The identification system of claim 4, wherein the inner portion comprises a depth which is greater than the thickness of the disk.

6. The identification system of claim 5, wherein the inner portion comprises a first diameter, the outer portion comprises a second diameter which is greater than the first diameter, and the shoulder comprises a generally square profile.

7. The identification system of claim 6, wherein the lip comprises an upper portion which is located proximate the bottom of a wear allowance zone of the component.

8. The identification system of claim 4, wherein the inner portion comprises a first diameter, the outer portion comprises a second diameter which is greater than the first diameter, and the shoulder comprises a radially inner portion which is located a first distance from the outer surface and a radially outer portion which is located a second distance from the outer surface, the first distance being less than the second distance.

9. The identification system of claim 8, wherein the shoulder comprises a generally triangular profile.

10. The identification system of claim 8, wherein the shoulder comprises a concave profile.

11. The identification system of claim 8, wherein the shoulder comprises a convex profile.

12. The identification system of claim 8, wherein the lip comprises an upper portion which is located proximate the bottom of a wear allowance zone of the component.

13. A method for providing a component with a unique identifying marking, the component having a body with an outer surface which in use is subject to wear, the method comprising:
providing an identification disk which comprises upper and lower faces and a thickness which is defined between the upper and lower faces;
disposing the identifying marking on at least the upper face;
forming a cavity in the body which extends from the outer surface to a depth which is greater than the thickness of the disk;
positioning the disk in the cavity such that the upper face is directed toward and disposed below the outer surface; and
forming a lip from a portion of the body adjacent the cavity such that, when the disk is positioned in the cavity, the lip overlaps an outer peripheral portion of the disk to thereby secure the disk in the cavity without obscuring the identifying marking.

14. The method of claim 13, wherein the lip comprises an upper portion which is located proximate the bottom of a wear allowance zone of the component.

15. The method of claim 13, wherein the identifying marking is also disposed on the lower face of the disk.

16. The method of claim 13, wherein the cavity comprises:
an inner portion within which the disk is positioned;
an outer portion which extends between the inner portion and the outer surface; and
a shoulder which is located between the inner and outer portions;
wherein the lip is formed from the shoulder.

17. The method of claim 16, wherein the inner portion comprises a depth which is greater than the thickness of the disk.

18. The method of claim 17, wherein the inner portion comprises a first diameter, the outer portion comprises a second diameter which is greater than the first diameter, and the shoulder comprises a generally square profile.

19. The method of claim 18, wherein the lip comprises an upper portion which is located proximate the bottom of a wear allowance zone of the component.

20. The method of claim 16, wherein the inner portion comprises a first diameter, the outer portion comprises a second diameter which is greater than the first diameter, and the shoulder comprises a radially inner portion which is located a first distance from the outer surface and a radially outer portion which is located a second distance from the outer surface, the first distance being less than the second distance.

21. The method of claim 20, wherein the shoulder comprises a generally triangular profile.

22. The method of claim 20, wherein the shoulder comprises a concave profile.

23. The method of claim 20, wherein the shoulder comprises a convex profile.

24. The method of claim 20, wherein the lip comprises an upper portion which is located proximate the bottom of a wear allowance zone of the component.
